(19) United States
(12) Patent Application Publication
(10) Pub. No.: US 2010/0044545 A1
(43) Pub. Date: Feb. 25, 2010

(54) CHRISTMAS TREE STAND

(76) Inventor: Brian Hackney, Poulsbo, WA (US)

Correspondence Address: Ruttler IP Law PLLC;One Union Square, 600 University Street, Suite 1919, Seattle, WA, 98101, US

(21) Appl. No.: 12/546,659

(22) Filed: Aug. 24, 2009

Related U.S. Application Data
(60) Provisional application No. 61/091,010, filed on Aug. 22, 2008.
(60) Provisional application No. 61/093,553, filed on Sep. 2, 2008.

(51) Int. Cl. F16M 11/22; F16M 13/00

(52) U.S. Cl. 248/514; 248/519; 248/523

(57) ABSTRACT

This invention relates generally to mechanics, and more specifically, to systems and methods for providing an improved Christmas tree stand. In one embodiment, the invention includes a Christmas tree stand including a base, the base defining a quarter-circle shape configured for placement in a ninety-degree room corner; and one or more radial extension members, the one or more radial extension members extending from the base.

### PRIORITY CLAIM

This application claims the benefit of U.S. provisional patent application Ser. No. 61/091,010 filed Aug. 22, 2008 (our ref. HACK-1-1001) and U.S. provisional patent application Ser. No. 61/093,553 filed Sep. 2, 2008 (our ref. HACK-1-1001-1). The foregoing applications are incorporated by reference in their entirety as if fully set forth herein.

### FIELD OF THE INVENTION

This invention relates generally to mechanics, and more specifically, to systems and methods for providing an improved Christmas tree stand.

### BACKGROUND

Christmas tree stands are used to mountably fix a tree in an upright position within living quarters. Traditional Christmas tree stands include a circular base and a central aperture for receiving the trunk of a Christmas tree. The central aperture often is configurable to storably receive water for tree uptake and includes adjustable screws for securing the trunk therein. Christmas trees mounted within traditional Christmas tree stands are disposable towards the center of a room, a wall, or a corner, but always require radial space sufficient to accommodate the tree branches and the tree stand.

The traditional Christmas tree stand was first invented at a time when living space was relatively plentiful. Older homes were typically quite large and there was ample room for desirably and unobstructedly placing a Christmas tree in a traditional Christmas tree stand within or near the center of a room. However, over time space has become more limited as more people are attracted to urban centers for work and play. While larger homes still exist, condominiums and apartments have become more viable alternatives to large detached single family homes. Their affordability and proximity to urban centers make them extremely attractive; however, they often have significantly less living square footage thereby placing a premium on appliances, furniture, and decorations that are both attractive and space-efficient.

Needless to say, Christmas trees mounted within traditional Christmas tree stands are not space-efficient. They are bulky, awkward, and wastefully consume an inordinate amount of living space, which makes them extremely problematic for all persons living in smaller spaces such as condominiums and apartments. As such, people have begun to forego celebrations using Christmas trees or choose laughable miniature substitutes; neither of which is optimal.

Accordingly, although desirable results have been achieved, there exists much room for improvement. What is needed then are systems and methods for providing an improved Christmas tree stand.

### SUMMARY

This invention relates generally to mechanics, and more specifically, to systems and methods for providing an improved Christmas tree stand. In one embodiment, the invention includes a Christmas tree stand including a base, the base defining a quarter-circle shape configured for placement in a ninety-degree room corner; and one or more radial extension members, the one or more radial extension members extending from the base.

### BRIEF DESCRIPTION OF THE DRAWINGS

Embodiments of the present invention are described in detail below with reference to the following drawings:

FIG. 1 is a side top perspective view of a Christmas tree stand, in accordance with an embodiment of the invention;

FIG. 2 is a front top perspective view of a Christmas tree stand, in accordance with an embodiment of the invention;

FIG. 3 is a top plan view of a Christmas tree stand, in accordance with an embodiment of the invention;

FIG. 4 is a side elevational view of a Christmas tree stand, in accordance with an embodiment of the invention;

FIG. 5 is a bottom plan view of a Christmas tree stand, in accordance with an embodiment of the invention;

FIG. 6 is a side top perspective view of a Christmas tree stand, in accordance with an embodiment of the invention;

FIG. 7 is a front top perspective view of a Christmas tree stand being used with a Christmas tree, in accordance with an embodiment of the invention;

FIG. 8 is a front top perspective view of a Christmas tree stand, in accordance with an embodiment of the invention;

FIG. 9 is a side top perspective view of a Christmas tree stand, in accordance with an embodiment of the invention;

FIG. 10 is a top plan view of a Christmas tree stand, in accordance with an embodiment of the invention;

FIG. 11 is a side elevational view of a Christmas tree stand, in accordance with an embodiment of the invention;

FIG. 12 is an exploded top plan view of a Christmas tree stand, in accordance with an embodiment of the invention;

FIG. 13 is a front top perspective view of a Christmas tree stand being used with a Christmas tree, in accordance with an embodiment of the invention;

FIG. 14 is a top plan view of a Christmas tree stand, in accordance with an embodiment of the invention;

FIG. 15 is an exploded top plan view of a Christmas tree stand, in accordance with an embodiment of the invention;

FIG. 16 is a side top perspective view of a Christmas tree stand being used with a Christmas tree, in accordance with an embodiment of the invention;

FIG. 17 is a front top perspective view of a Christmas tree stand, in accordance with an embodiment of the invention;

FIG. 18 is a front top perspective view of a Christmas tree stand, in accordance with an embodiment of the invention;

FIG. 19 is a top plan view of a Christmas tree stand, in accordance with an embodiment of the invention;

FIG. 20 is a side elevational view of a Christmas tree stand, in accordance with an embodiment of the invention;

FIG. 21 is an exploded top plan view of a Christmas tree stand, in accordance with an embodiment of the invention;

FIG. 22 is an exploded side elevational view of a Christmas tree stand, in accordance with an embodiment of the invention;

FIG. 23 is an exploded top plan view of a Christmas tree stand, in accordance with an embodiment of the invention;

FIG. 24 is a top plan view of a Christmas tree stand, in accordance with an embodiment of the invention;

FIG. 25 is a front top perspective view of a Christmas tree stand being used with a Christmas tree, in accordance with an embodiment of the invention;

FIG. 26 is a front top perspective view of a Christmas tree stand being used with a Christmas tree, in accordance with an embodiment of the invention;

FIG. 27 is a front top perspective view of a Christmas tree stand, in accordance with an embodiment of the invention;

FIG. 28 is a front top perspective view of a Christmas tree stand, in accordance with an embodiment of the invention;

FIG. 29 is a top plan view of a Christmas tree stand, in accordance with an embodiment of the invention;

FIG. 30 is a side elevational view of a Christmas tree stand, in accordance with an embodiment of the invention;

FIG. 31 is an exploded side elevational view of a Christmas tree stand, in accordance with an embodiment of the invention;

FIG. 32 is an exploded bottom plan view of a Christmas tree stand, in accordance with an embodiment of the invention;

FIG. 33 is an exploded top plan view of a Christmas tree stand, in accordance with an embodiment of the invention;

FIG. 34 is a top plan view of a Christmas tree stand, in accordance with an embodiment of the invention;

FIG. 35 is a front top perspective view of a Christmas tree stand being used with a Christmas tree, in accordance with an embodiment of the invention;

FIG. 36 is a front top perspective view of a Christmas tree stand being used with a Christmas tree, in accordance with an embodiment of the invention;

FIG. 37 is an exploded front elevational view of a Christmas tree stand, in accordance with an embodiment of the invention;

FIG. 38 is an exploded side top perspective view of a Christmas tree stand, in accordance with an embodiment of the invention;

FIG. 39 is a top plan view of a Christmas tree stand, in accordance with an embodiment of the invention;

FIG. 40 is a side elevational view of a Christmas tree stand, in accordance with an embodiment of the invention; and

FIG. 41 is a bottom plan view of a Christmas tree stand, in accordance with an embodiment of the invention.

### DETAILED DESCRIPTION

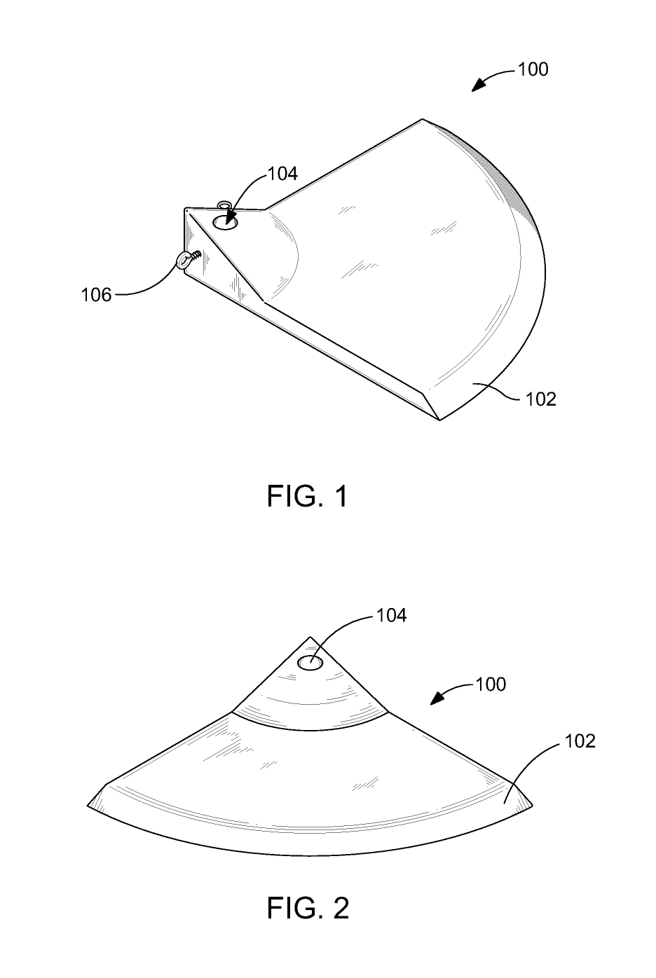

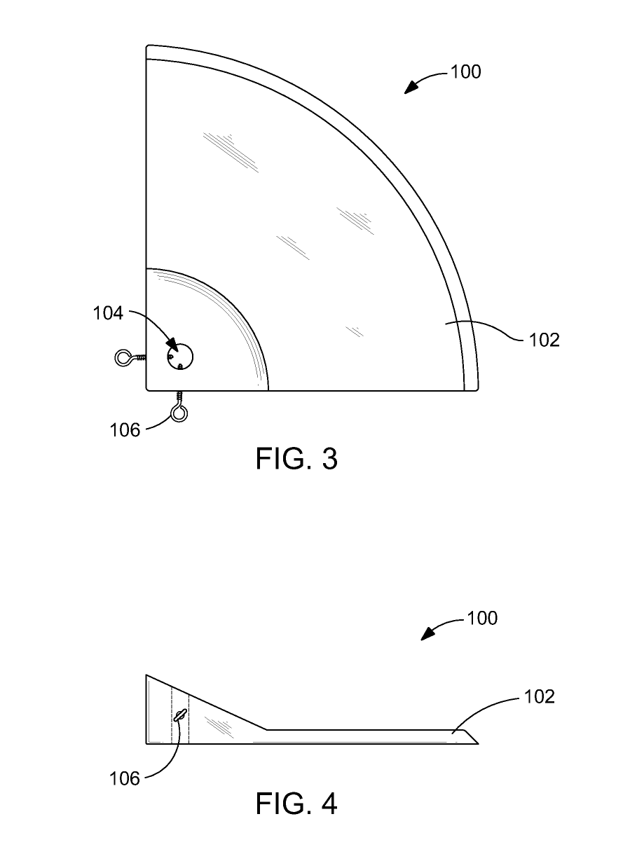

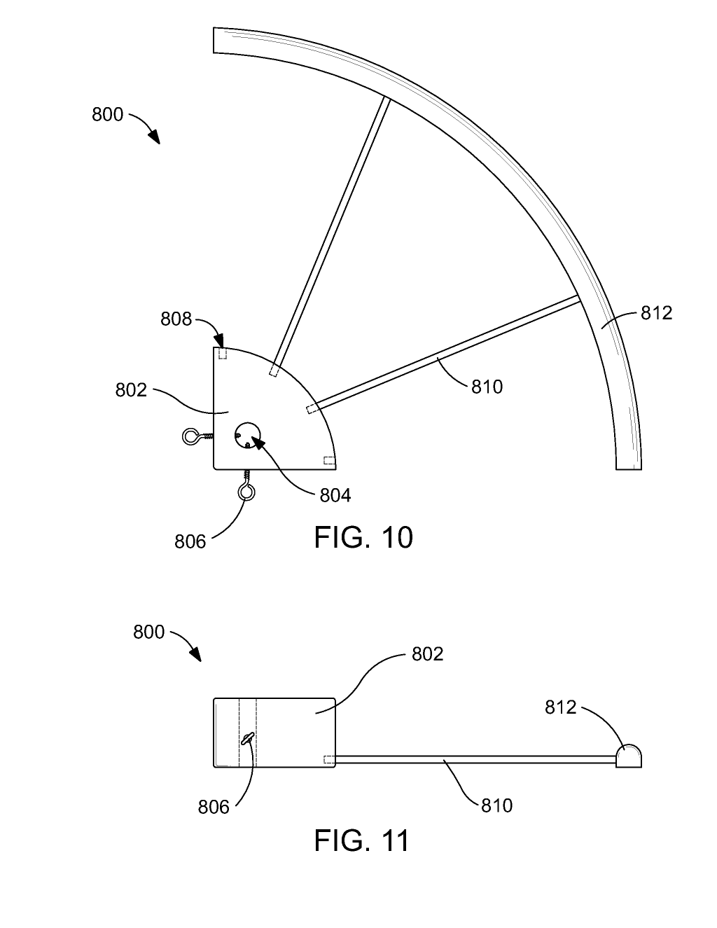

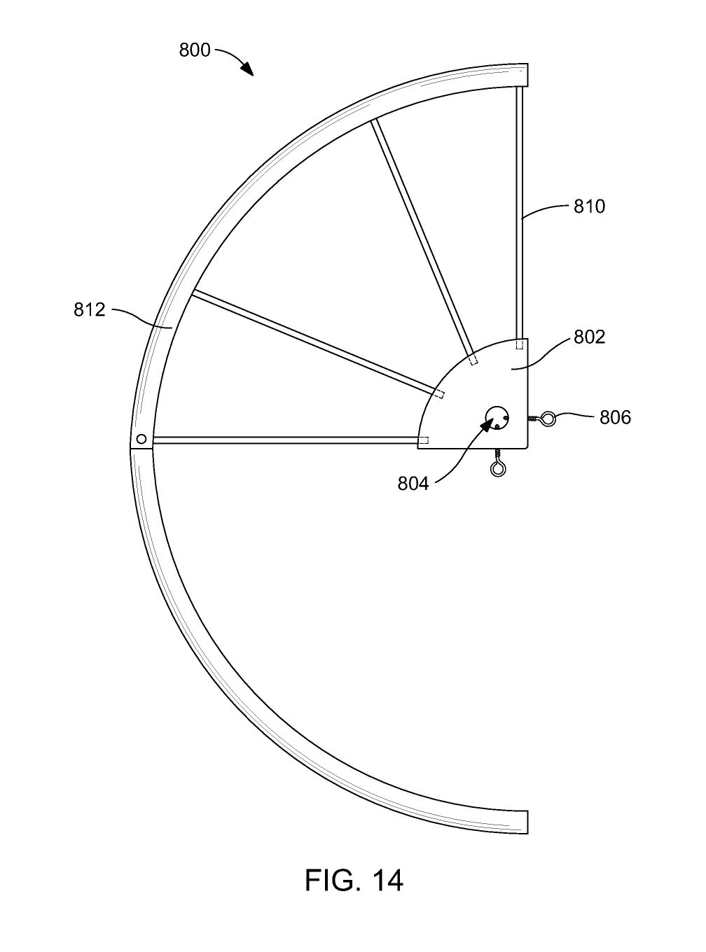

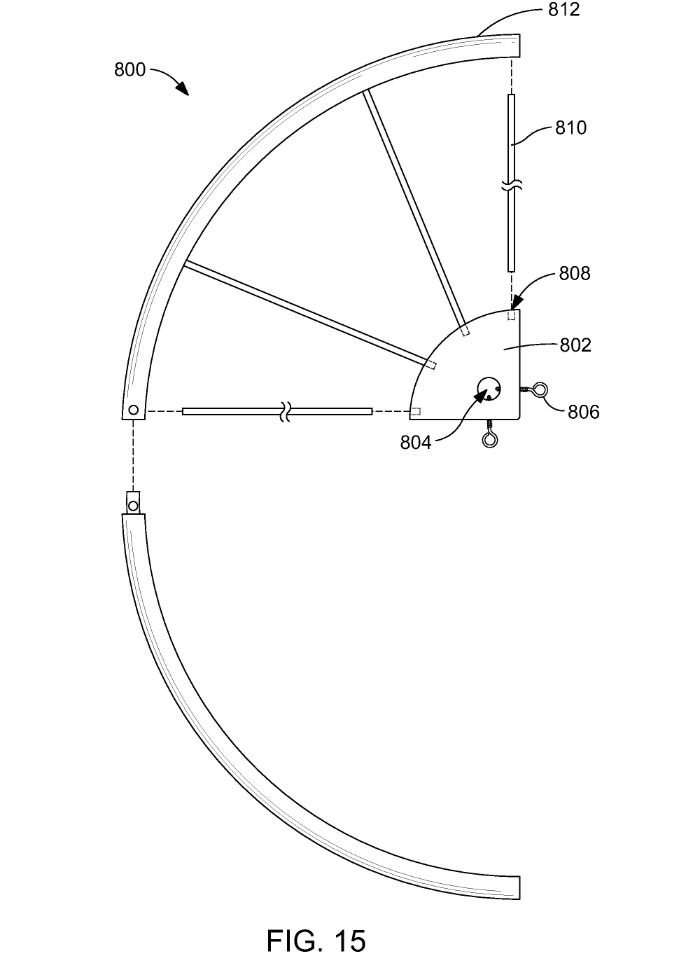

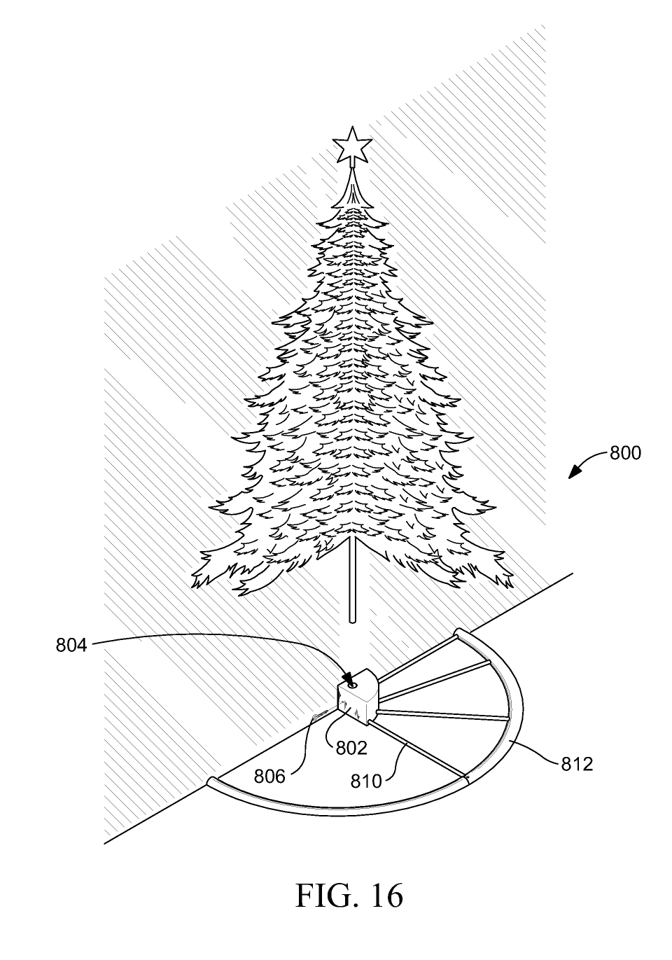

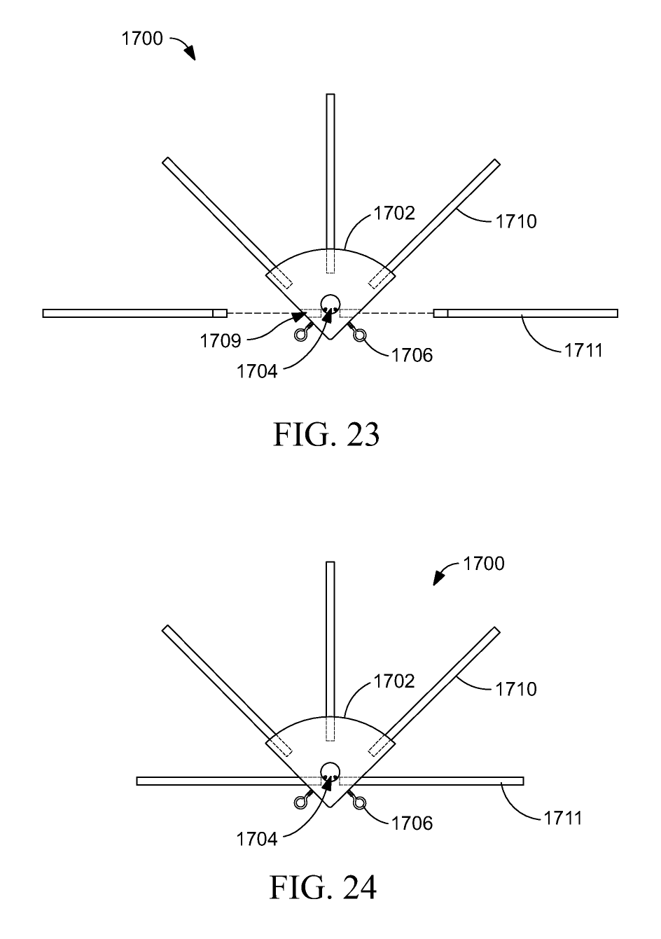

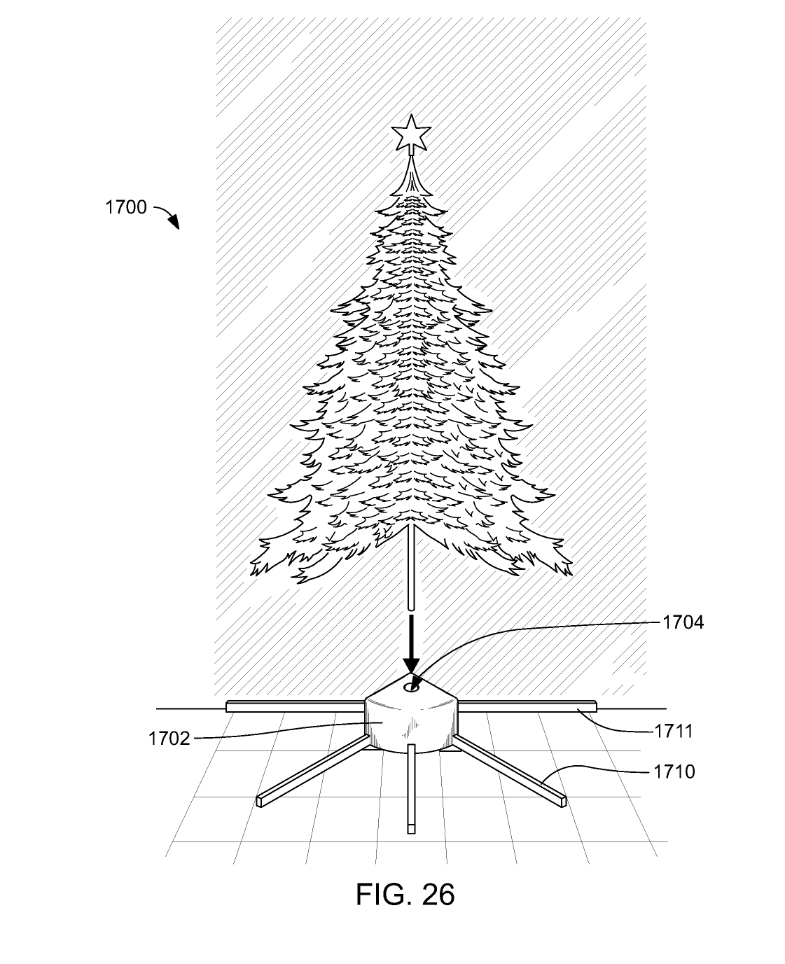

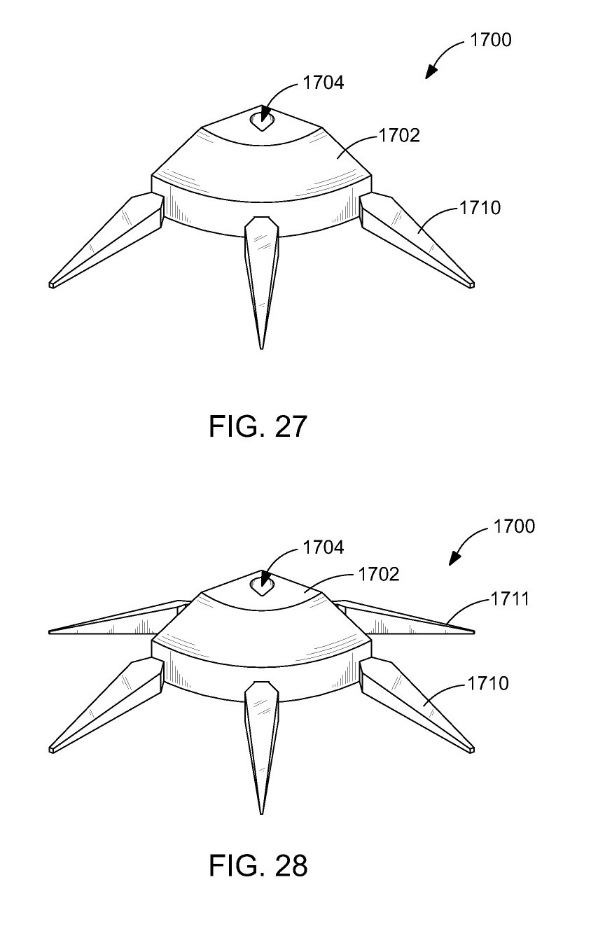

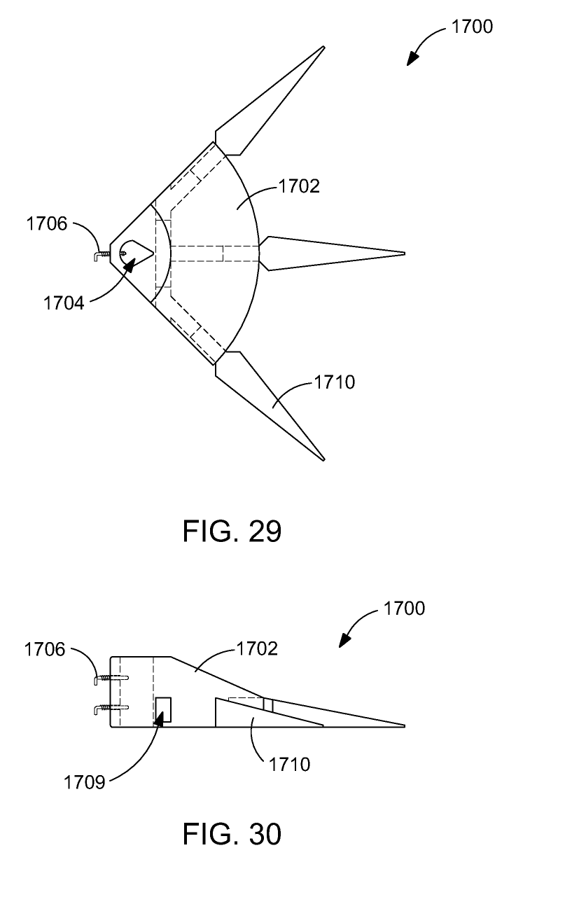

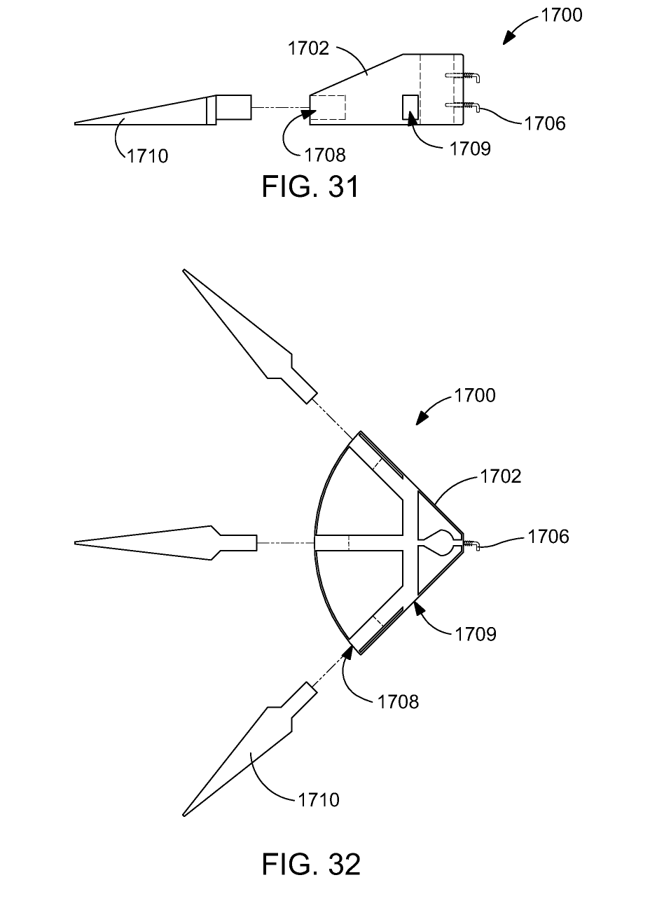

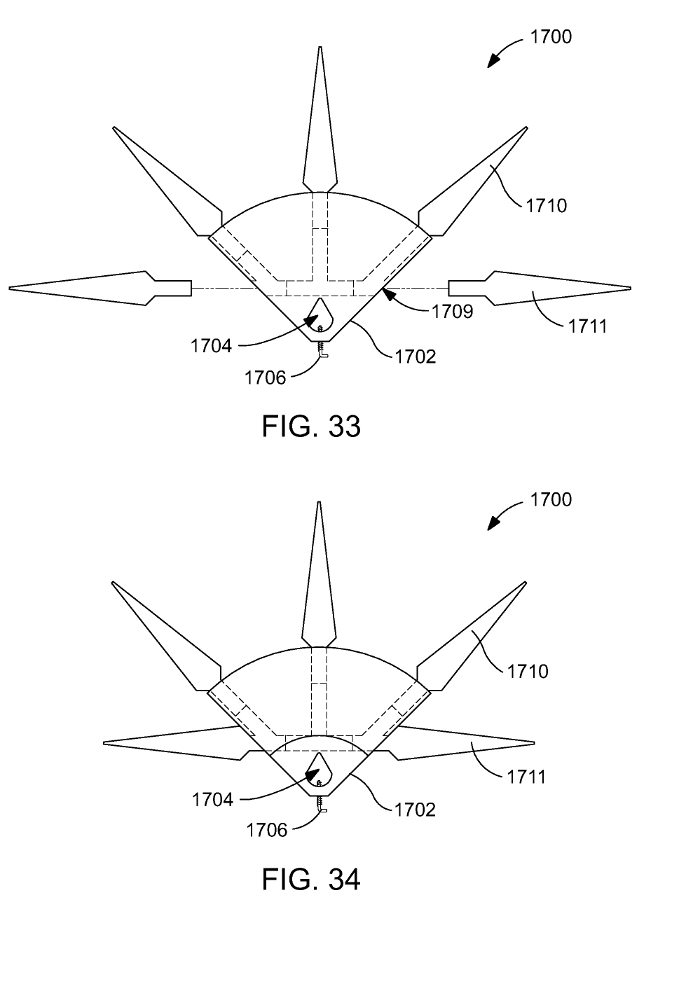

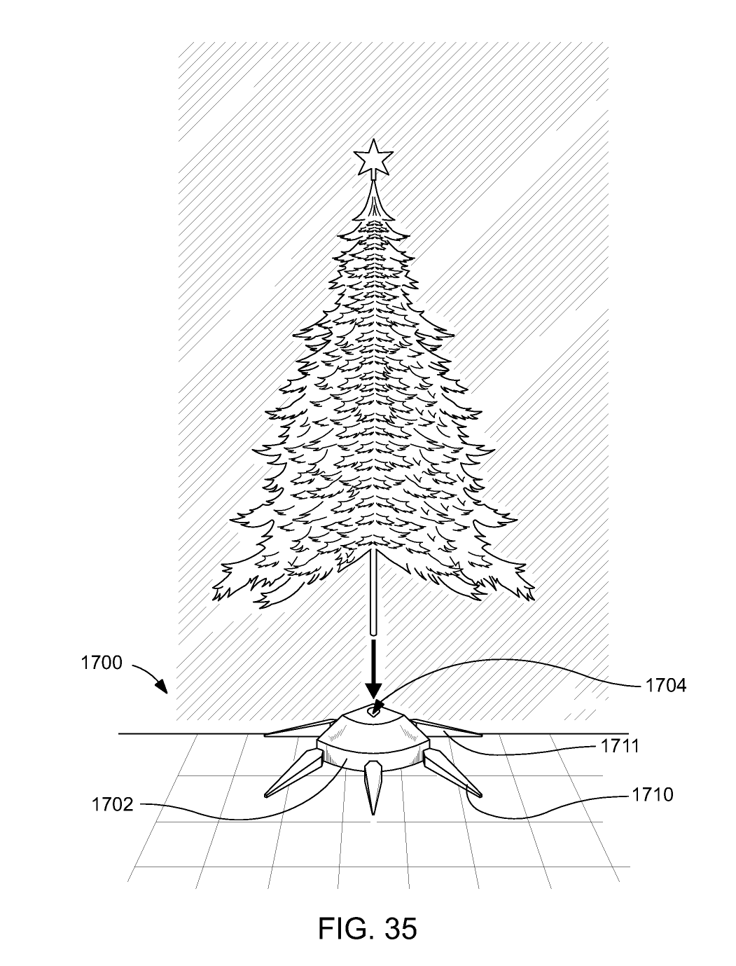

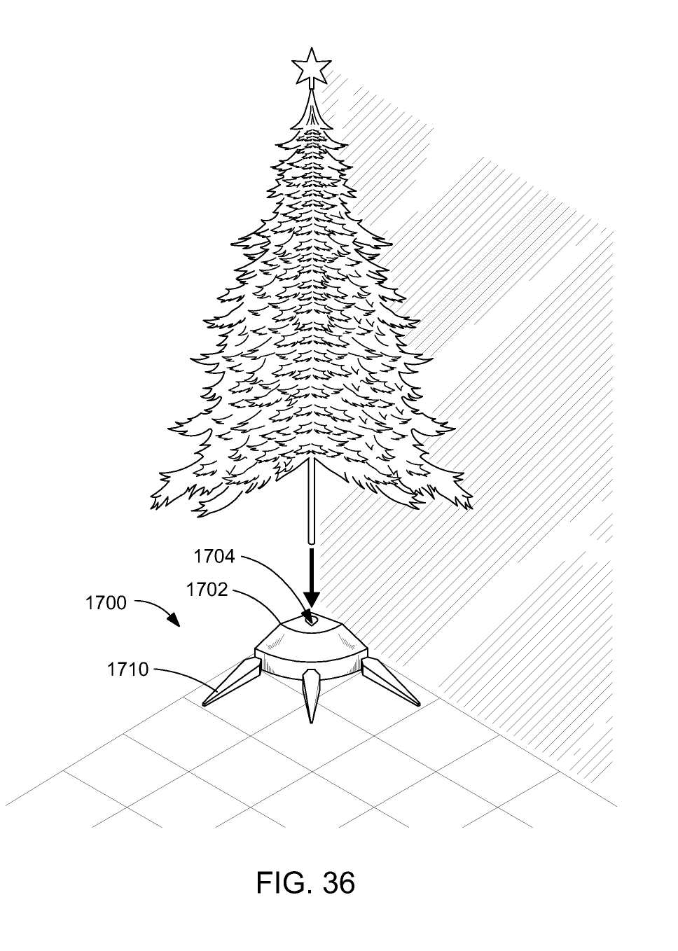

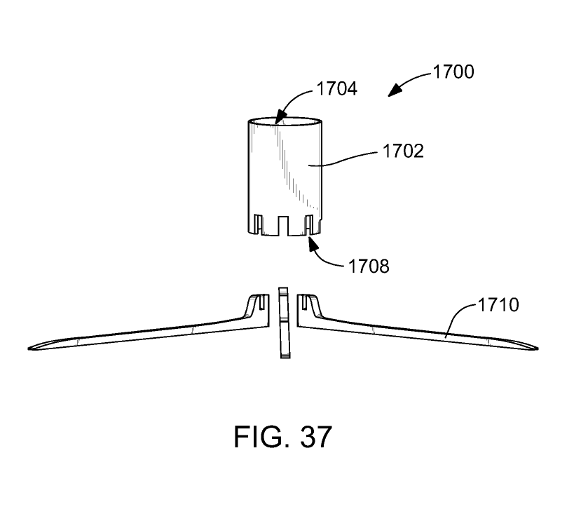

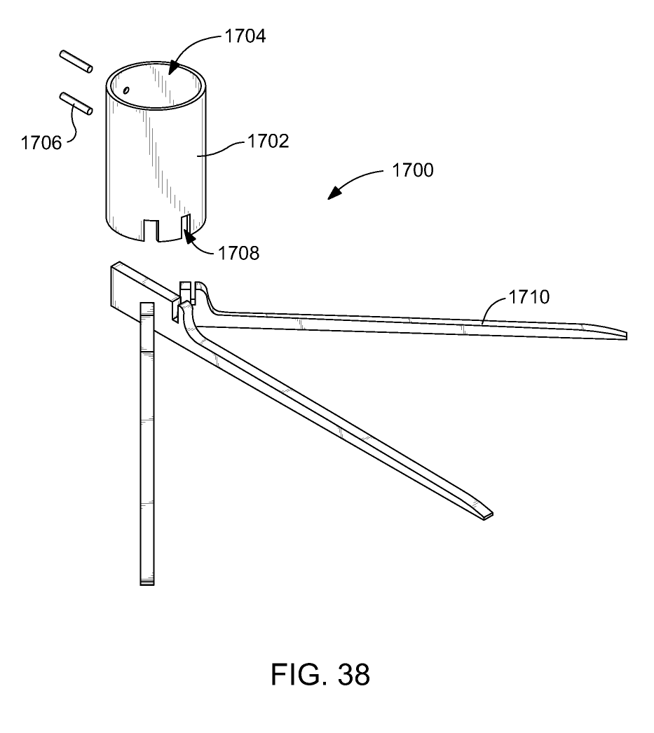

This invention relates generally to mechanics, and more specifically, to systems and methods for providing an improved Christmas tree stand. Specific details of certain embodiments of the invention are set forth in the following description and in FIGS. 1-41 to provide a thorough understanding of such embodiments. The present invention may have additional embodiments, may be practiced without one or more of the details described for any particular described embodiment, or may have any detail described for one particular embodiment practiced with any other detail described for another embodiment.

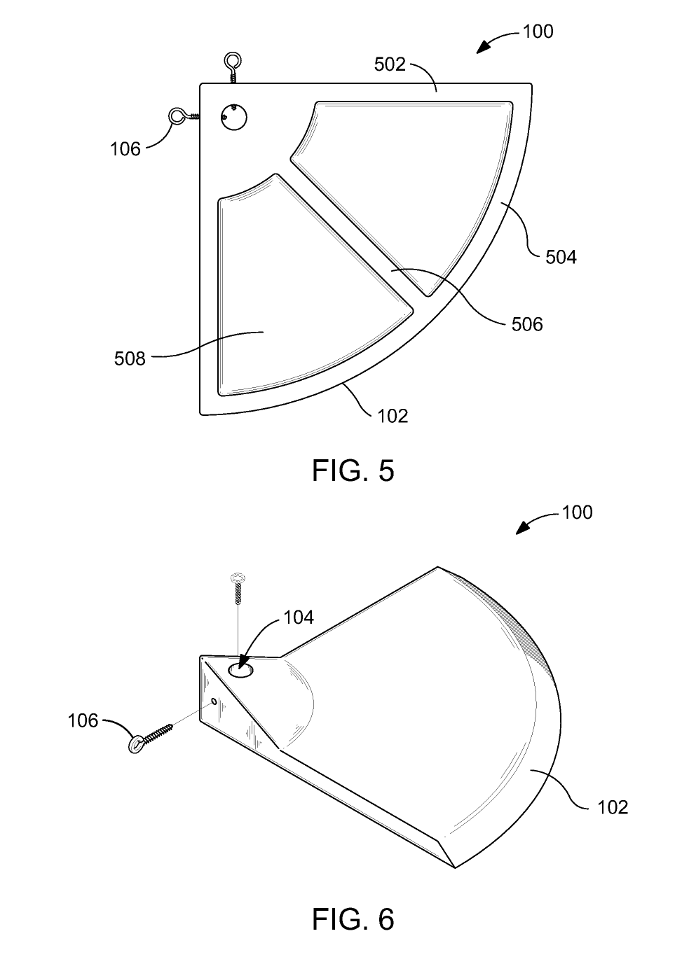

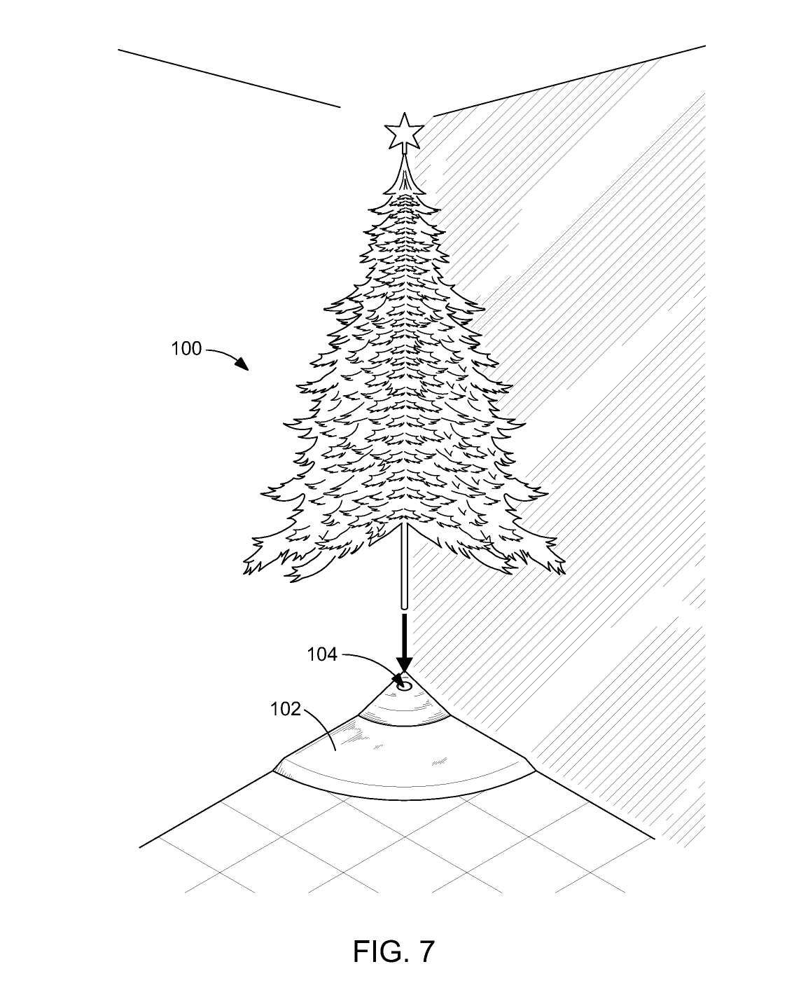

FIGS. 1-7 are various views of a Christmas tree stand, in accordance with an embodiment of the invention. In one embodiment, the Christmas tree stand 100 includes a base 102 having an aperture 104 and one or more fasteners 106. The base 102 is defined by one or more outer radial members 502 (FIG. 5) that extend outwardly and approximately perpendicularly from a center portion of the base 102. The one or more outer radial members 502 are coupled at their distal ends by circumferential member 504 (FIG. 5). A center radial member 506 (FIG. 5) is disposed between the one or more outer radial members 502 and also extends outwardly from a center portion of the base 102 to couple with the circumferential member 504. A cover 508 (FIG. 5) is disposed over the outer, center, and circumferential members to conceal the same from view. The aperture 104 is disposed proximate to the center portion of the base 102 and defines a cavity that is configurable to removably receive a trunk of a Christmas tree (FIG. 7). The one or more fasteners 106 are usable to removably secure the trunk within the aperture 104. Accordingly, a Christmas tree is securable within the aperture 104 using the one or more fasteners 106 and the Christmas tree stand 100 is placeable in a corner of a room with the center portion of the base 102 disposed in the corner and the one or more outer radial members 502 extending along the walls defining the corner (FIG. 7). The branches of the Christmas tree can be trimmed to accommodate the walls or, such as in the case of artificial trees, can be reformed away from the walls to provide an even fuller Christmas tree.

In various embodiments, the Christmas tree stand 100 is composed of plastic, metal, ceramic, glass, wood, synthetic, another material, or a combination of the foregoing. In another embodiment, the base 102 is alternatively constructed such as by using fewer or greater numbers of members or using a single piece construction. In an additional embodiment, any of the outer, center, and circumferential members are linear, concave, convex, or non-uniformly shaped. In a further embodiment, the outer radial members extend more or less than ninety degrees from one another, such as a hundred and eighty degrees or two hundred and seventy degrees from one another. In an additional embodiment, the cover 508 is omitted, integrated with the members, or substituted with an alternative structure, such as one defining apertures therein. In an additional embodiment, the one or more fasteners 106 are screws, bolts, clamps, pins, another fastener, or a combination of the foregoing. In yet another embodiment, the one or more fasteners 106 are omitted. In an additional embodiment, the aperture 104 is disposed at or slidably movable to a different position on the base 102, such as outwardly from the center portion of the base 102. In a further embodiment, the aperture 104 includes a reservoir for storably receiving water for tree uptake. In yet another embodiment, the Christmas tree stand 100 includes a power outlet for electrically coupling Christmas lights or another power consuming device to a wall outlet. In one particular embodiment, the power outlet includes an adjustable timer for automatically turning power on and off at certain times of the day. In a further embodiment, the Christmas tree stand 100 includes solar cells for recharging a battery to provide power to the Christmas lights or other power consuming devices. In other embodiments, the base 102 or aperture 104 is height adjustable. In a similar embodiment, the base 102 or aperture 104 is angularly adjustable. In another embodiment, the Christmas tree stand 100 is producible in various sizes to accommodate different Christmas tree sizes. In a further embodiment, the Christmas tree stand 100 is usable to support any plant, bush, tree, flower whether natural or artificial or even any other tangible device.

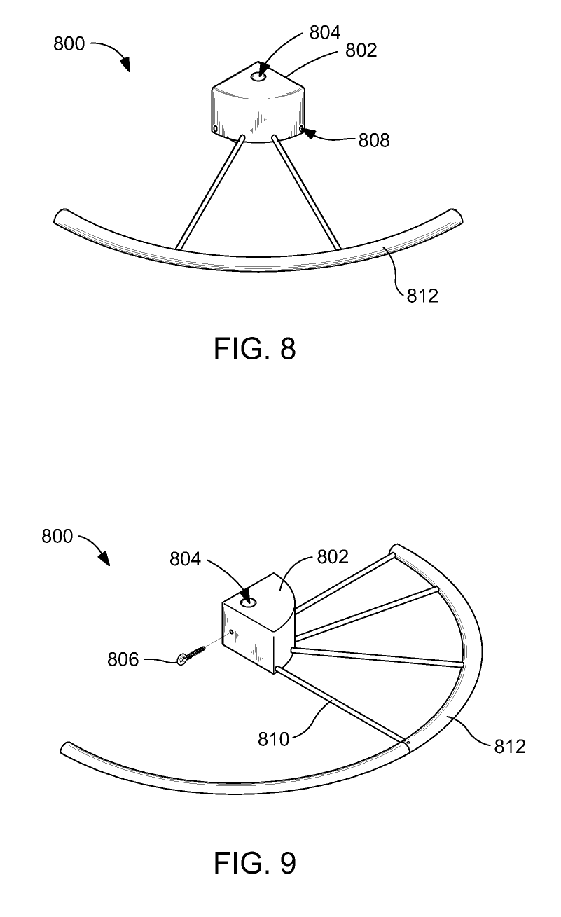

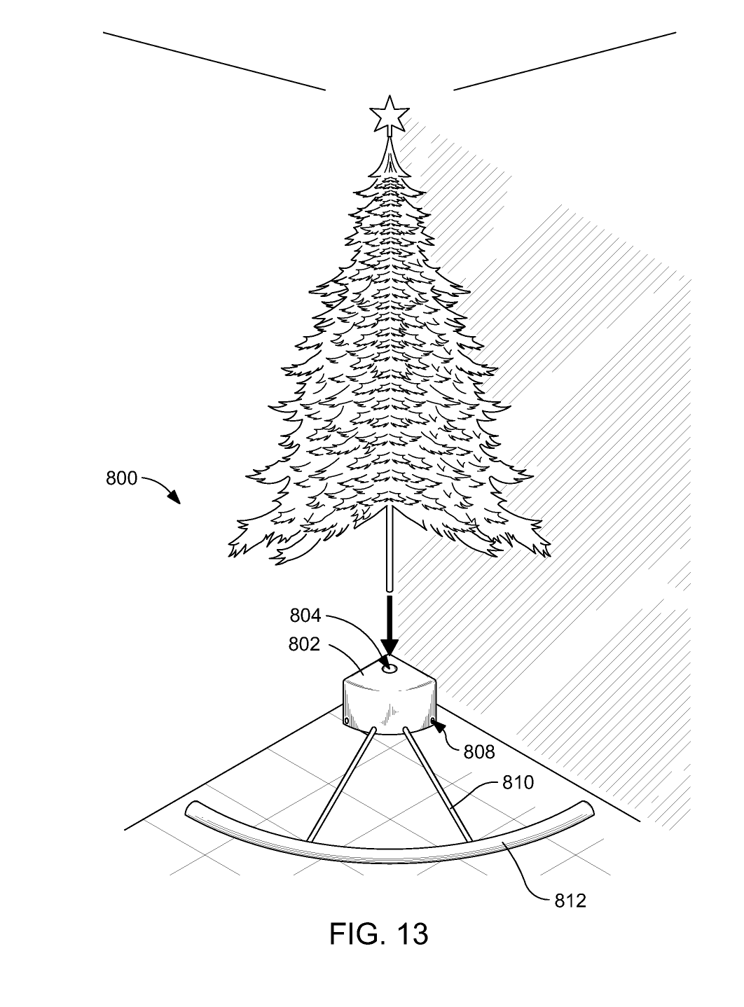

FIGS. 8-16 are various views of a Christmas tree stand, in accordance with an embodiment of the invention. In one embodiment, the Christmas tree stand 800 includes an extendable base 802 having an aperture 804 and one or more fasteners 806 (FIG. 9). The extendable base 802 is defined by a quarter-circle-shaped center anchor having one or more radial extension member mounts 808 disposed about its arced perimeter, such as at intervals of approximately thirty degrees. One or more radial extension members 810 are removably mountable to the extendable base 802 using the one or more radial extension member mounts 808 and are configurable to extend radially therefrom. The one or more radial extension members 810 couple distally to a circumferential member 812 that defines approximately a ninety degree arc. Together, the one or more radial extension members 810 and the circumferential member 812 can provide enhanced stability to the extendable base 802. The aperture 804 is disposed within the extendable base 802 and defines a cavity that is configurable to removably receive a trunk of a Christmas tree (FIG. 13). The one or more fasteners 806 are usable to removably secure the trunk within the aperture 804. Accordingly, a Christmas tree is securable within the aperture 804 using the one or more fasteners 806 and the Christmas tree stand 800 is placeable in a corner of a room with the extendable base 802 disposed in the corner and the one or more radial extension members 810 extending radially therefrom to couple with the circumferential member 812 that extends approximately between each of the opposing corner walls. The branches of the Christmas tree can be trimmed to accommodate the walls or, such as in the case of artificial trees, can be reformed away from the walls to provide an even fuller Christmas tree.

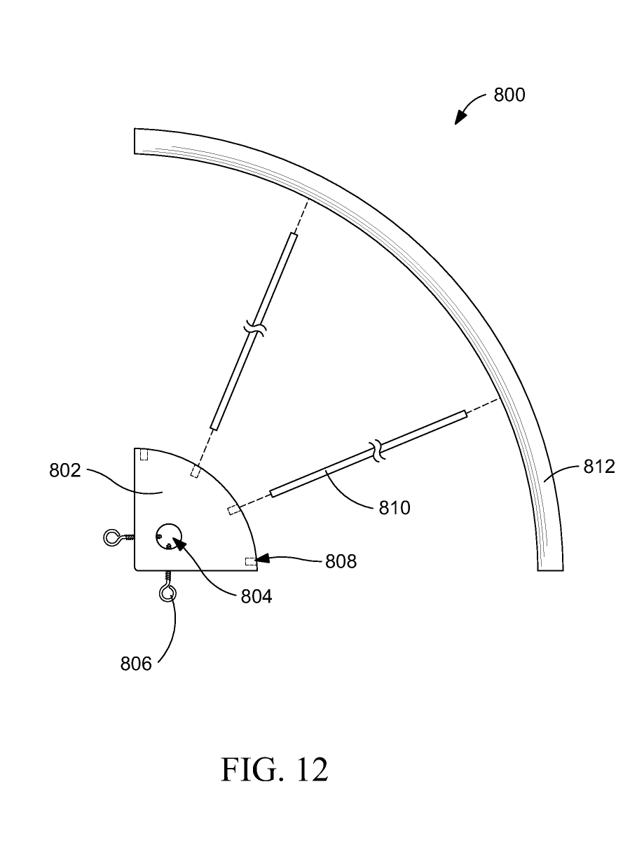

In various embodiments, the Christmas tree stand 800 is composed of plastic, metal, ceramic, glass, wood, synthetic, another material, or a combination of the foregoing. In an additional embodiment, the one or more fasteners 806 are screws, bolts, clamps, pins, another fastener, or a combination of the foregoing. In yet another embodiment, the one or more fasteners 806 are omitted. In an additional embodiment, the aperture 804 is disposed at or slidably movable to a different position on the extendable base 802. In a further embodiment, the aperture 804 includes a reservoir for storably receiving water for tree uptake. In another embodiment, the one or more radial extension member mounts 808 are apertures, extrusions, holes, hooks, snaps, clamps, or other similar fasteners for receiving the one or more radial extension members 810. Alternatively, the one or more radial extension members 810 are permanently coupled to the extendable base 802. In a further embodiment, the extendable base 802 has fewer or greater numbers of the one or more radial extension member mounts 808. In an alternate embodiment, the one or more radial extension member mounts 808 are disposed at different uniform or non-uniform intervals or positions. In a further embodiment, the there are fewer or greater numbers of the one or more radial extension members 810. In yet a further embodiment, the one or more radial extension members 810 are adjustably extensible (FIG. 12). In different embodiments, the one or more radial extension members 810 are differently shaped, such as flat, curvilinear, or some other regular or irregular shape. In a further embodiment, the circumferential member 812 defines an arc of a greater or lesser degree or is adjustable. In an alternative embodiment, the circumferential member 812 is coupled more centrally relative to the one or more radial extension members 810. In a further embodiment, the circumferential member 812 is omitted or is differently shaped, such as flat, curvilinear, or some other regular or irregular shape. In yet another embodiment, the extendable base 802 defines an alternative shape, such as a half-circle, circle, square, triangle, oval, rectangle, or any other uniform or non-uniform geometric shape. In an additional embodiment, the circumferential member 812 is extensible (FIGS. 9, 14-16), such as to define a hundred and eighty degree, two hundred and seventy degree, or other arc. In yet another embodiment, the Christmas tree stand 800 includes a power outlet for electrically coupling Christmas lights or another power consuming device to a wall outlet. In one particular embodiment, the power outlet includes an adjustable timer for automatically turning power on and off at certain times of the day. In a further embodiment, the Christmas tree stand 800 includes solar cells for recharging a battery to provide power to the Christmas lights or other power consuming devices. In other embodiments, the extendable base 802 or aperture 804 is height adjustable. In a similar embodiment, the extendable base 802 or aperture 804 is angularly adjustable. In another embodiment, the Christmas tree stand 800 is producible in various sizes to accommodate different Christmas tree sizes. In a further embodiment, the Christmas tree stand 800 is usable to support any plant, bush, tree, flower whether natural or artificial or even any other tangible device.

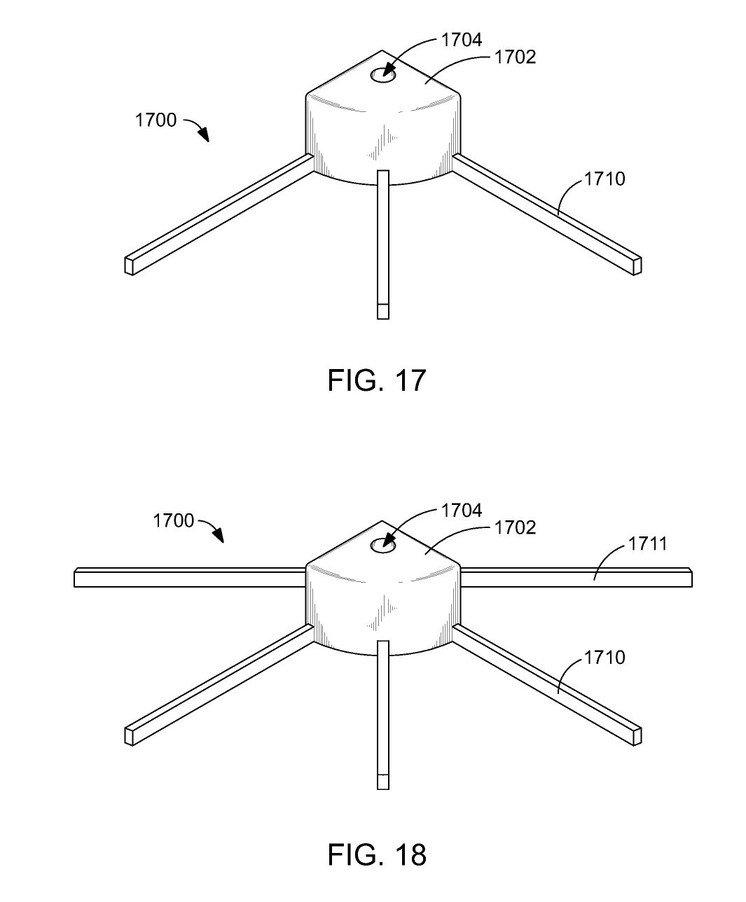

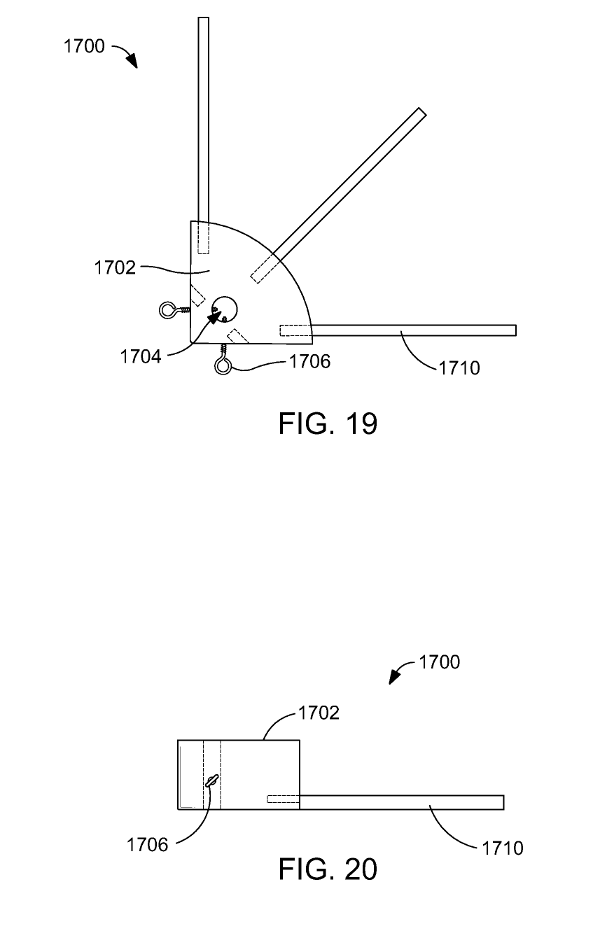

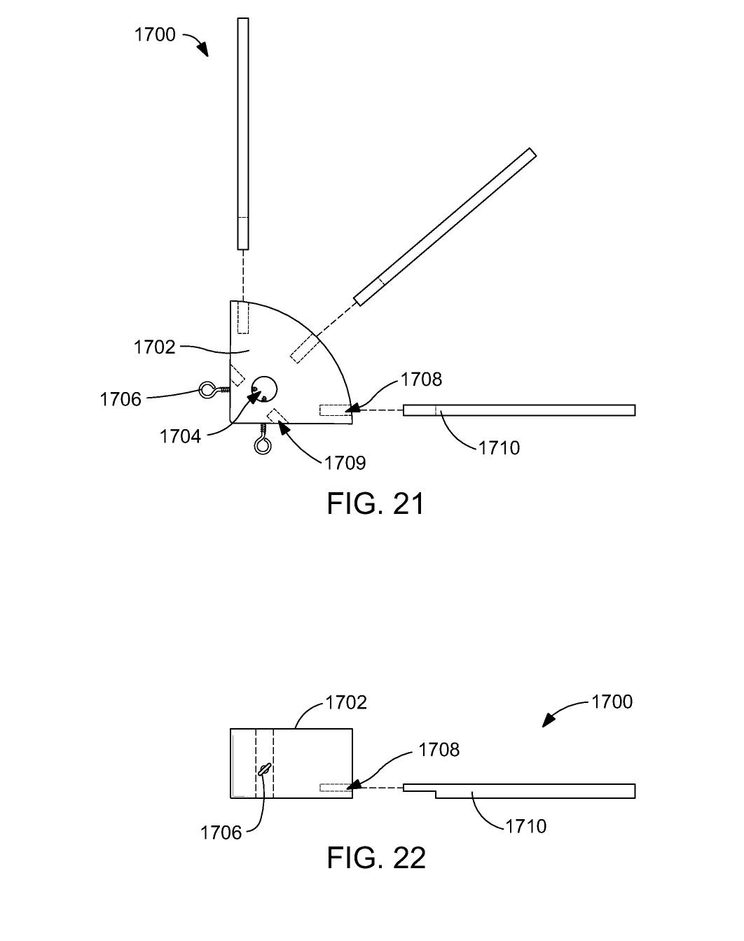

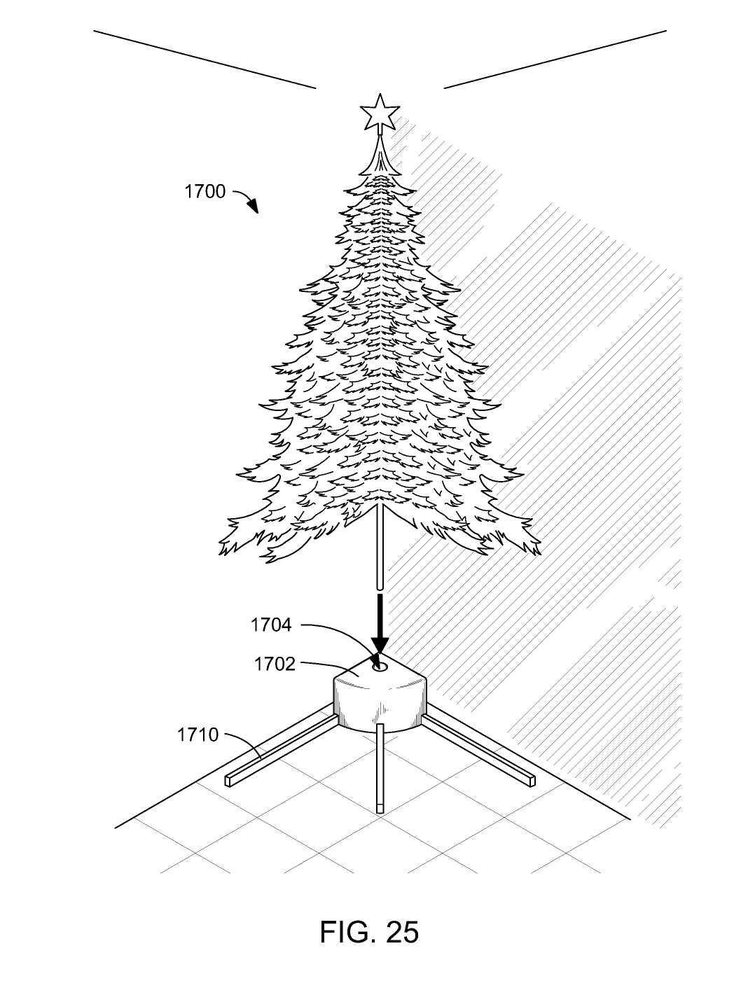

FIGS. 17-38 are various views of a Christmas tree stand, in accordance with an embodiment of the invention. In one embodiment, the Christmas tree stand 1700 includes a base 1702 having an aperture 1704 and one or more fasteners 1706 (FIG. 19). The base 1702 is defined by a quarter-circle-shaped center anchor having one or more radial extension member mounts 1708 disposed about its arced perimeter, such as at intervals of approximately forty-five degrees (FIG. 21). Additionally, one or more lateral extension member mounts 1709 are disposed proximate to the corner defined by the quarter circle (FIG. 21). One or more radial extension members 1710 are removably mountable to the base 1702 using the one or more radial extension member mounts 1708 and are configurable to extend radially therefrom. Optionally, one or more lateral extension members 1711 are removably mountable to the base 1702 using the one or more lateral extension member mounts 1709 and are configurable to extend laterally therefrom (FIG. 18). Together, the radial and lateral extension members can provide enhanced stability to the base 1702. The aperture 1704 is disposed within the base 1702 and defines a cavity that is configurable to removably receive a trunk of a Christmas tree (FIGS. 25, 26, 35, 36). The one or more fasteners 1706 are usable to removably secure the trunk within the aperture 1704. In one particular embodiment, the aperture 1704 defines a half-circle/triangle shaped cavity and the one or more fasteners 1706 are usable to removably secure the trunk within the aperture 1704 against the walls defined by the triangular portion of the cavity. Accordingly, a Christmas tree is securable within the aperture 1704 using the one or more fasteners 1706 and the Christmas tree stand 1700 is placeable in a corner of a room with the base 1702 disposed in the corner and the one or more radial extension members 1710 extending radially therefrom. Alternatively, the Christmas tree stand 1700 is placeable against a wall of a room with the base 1702 disposed against the wall and the radial and lateral extension members extending radially and laterally therefrom. The branches of the Christmas tree can be trimmed to accommodate the walls or, such as in the case of artificial trees, can be reformed away from the walls to provide an even fuller Christmas tree.

In various embodiments, the Christmas tree stand 1700 is composed of plastic, metal, ceramic, glass, wood, synthetic, another material, or a combination of the foregoing. In an additional embodiment, the one or more fasteners 1706 are screws, bolts, clamps, pins, another fastener, or a combination of the foregoing. In yet another embodiment, the one or more fasteners 1706 are omitted. In an additional embodiment, the aperture 1704 is disposed at or slidably movable to a different position on the base 1702. In a further embodiment, the aperture 1704 includes a reservoir for storably receiving water for tree uptake. In another embodiment, the mounts are apertures, extrusions, holes, hooks, snaps, clamps, or other similar fasteners for receiving the radial or lateral extension members. Alternatively, the radial or lateral extension members are permanently coupled to the base 1702. In a further embodiment, the base 1702 has fewer or greater numbers of mounts. In an alternate embodiment, the mounts are disposed at different uniform or non-uniform intervals or positions. In a further embodiment, the there are fewer or greater numbers of radial or lateral extension members. In yet a further embodiment, the radial or lateral extension members are adjustably extensible. In different embodiments, the radial or lateral extension members are differently shaped, such as flat, curvilinear, or some other regular or irregular shape. In yet another embodiment, the base 1702 defines an alternative shape, such as a half-circle, circle, square, triangle, oval, rectangle, or any other uniform or non-uniform geometric shape. In yet another embodiment, the Christmas tree stand 1700 includes a power outlet for electrically coupling Christmas lights or another power consuming device to a wall outlet. In one particular embodiment, the power outlet includes an adjustable timer for automatically turning power on and off at certain times of the day. In a further embodiment, the Christmas tree stand 1700 includes solar cells for recharging a battery to provide power to the Christmas lights or other power consuming devices. In other embodiments, the base 1702 or aperture 1704 is height adjustable. In a similar embodiment, the base 1702 or aperture 1704 is angularly adjustable. In another embodiment, the Christmas tree stand 1700 is producible in various sizes to accommodate different Christmas tree sizes. In a further embodiment, the Christmas tree stand 1700 is usable to support any plant, bush, tree, flower whether natural or artificial or even any other tangible device.

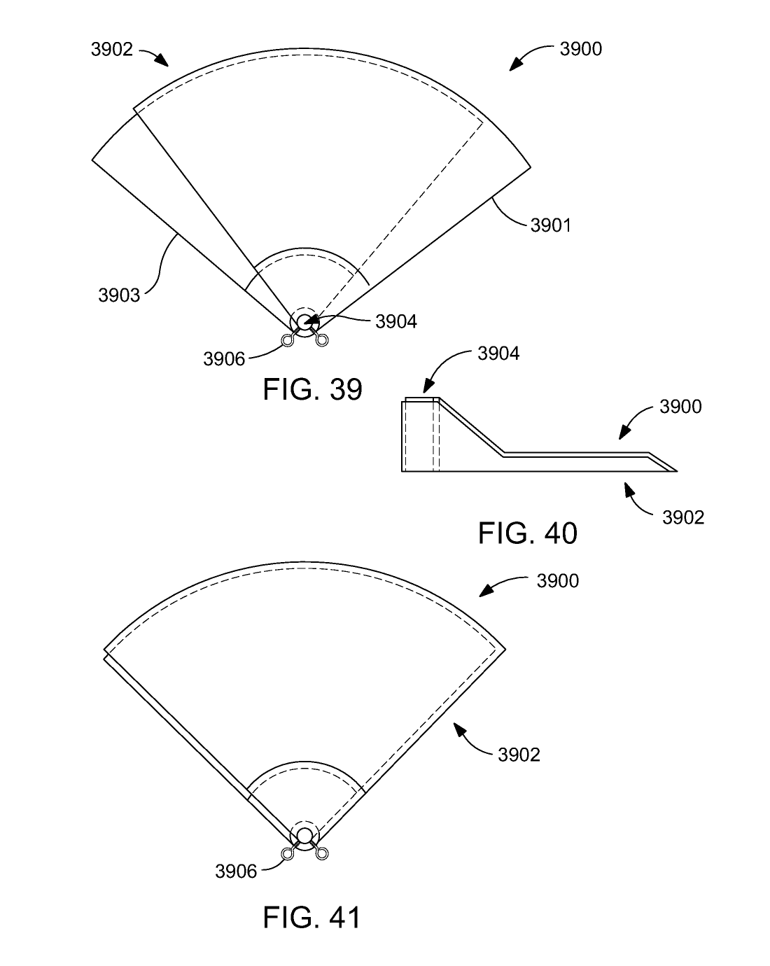

FIGS. 39-41 are various views of a Christmas tree stand, in accordance with an embodiment of the invention. In one embodiment, the Christmas tree stand 3900 includes an expandable base 3902 having an aperture 3904 and one or more fasteners 3906. The expandable base 3902 is composed of first 3901 and second 3903 overlapping fan portions. Each of the first 3901 and second 3903 overlapping fan portions is defined by an approximately quarter circle panel having reinforced outer radial edges extending approximately perpendicular towards a reinforced outer circumferential edge (not labeled). The first fan portion 3901 is disposed above the second fan portion 3903 and both are rotatably coupled centrally at a hinge, wherein the second fan portion 3903 can be entirely overlapped or exposed by the first fan portion 3901. The hinge defines the aperture 3904 for removably receiving a trunk of a Christmas tree. The one or more fasteners 3906 are usable to removably secure the trunk within the aperture 3904 at different positions of the first 3901 and second 3903 fan portions. Accordingly, a Christmas tree is securable within the aperture 3904 using the one or more fasteners 3906 and the Christmas tree stand 3900 is placeable against a wall or in a corner of a room. The second fan portion 3903 can be entirely overlapped by the first fan portion 3901 to define a unified quarter circle panel for placing the Christmas tree stand in a corner of a room. Alternatively, the second fan portion 3903 can be entirely exposed by the first fan portion 3901 to define a unified half circle panel for placing the Christmas tree stand 3900 against a wall. Similarly, the second fan portion 3903 can be partially exposed by the first fan portion 3901 to define a unified partial circle panel for placing the Christmas tree stand 3900 against an oddly angled wall. The branches of the Christmas tree can be trimmed to accommodate the walls or, such as in the case of artificial trees, can be reformed away from the walls to provide an even fuller Christmas tree.

In various embodiments, the Christmas tree stand 3900 is composed of plastic, metal, ceramic, glass, wood, synthetic, another material, or a combination of the foregoing. In another embodiment, the base 3902 is alternatively constructed such as by using fewer or greater numbers of fan portions or by using differently shaped fan portions. In one particular embodiment, the fan portions can extend apart from one another or can define more than a half circle, such as a three quarter circle. In one particular embodiment, the fan portions are differently or entirely reinforced. In an additional embodiment, any of the edges of the fan portions are linear, concave, convex, or non-uniformly shaped. In a further embodiment, the outer radial edges extend more or less than ninety degrees from one another. In an additional embodiment, any of the fan portions are composed of exposed or covered radial members. In an additional embodiment, the one or more fasteners 3906 are screws, bolts, clamps, pins, another fastener, or a combination of the foregoing. In yet another embodiment, the one or more fasteners 3906 are omitted. In an additional embodiment, the aperture 3904 is disposed at or slidably movable to a different position on the base 3902, such as outwardly from the center portion of the base 3902 or apart from the hinge. In a further embodiment, the aperture 3904 includes a reservoir for storably receiving water for tree uptake. In yet another embodiment, the Christmas tree stand 3900 includes a power outlet for electrically coupling Christmas lights or another power consuming device to a wall outlet. In one particular embodiment, the power outlet includes an adjustable timer for automatically turning power on and off at certain times of the day. In a further embodiment, the Christmas tree stand 3900 includes solar cells for recharging a battery to provide power to the Christmas lights or other power consuming devices. In other embodiments, the base 3902 or aperture 3904 is height adjustable. In a similar embodiment, the base 3902 or aperture 3904 is angularly adjustable. In another embodiment, the Christmas tree stand 3900 is producible in various sizes to accommodate different Christmas tree sizes. In a further embodiment, the Christmas tree stand 3900 is usable to support any plant, bush, tree, flower whether natural or artificial or even any other tangible device.

In one embodiment, the invention includes an artificial Christmas tree configurable to being reformed to fit against a wall or in a corner or to having a shape that accommodates a wall or a corner. In another embodiment, the invention includes cutting, pruning, or bending tools for shaping a Christmas tree to fit against a wall or in a corner.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

1. A Christmas tree stand comprising:
a base, the base defining a shape configured for placement in a ninety-degree room corner.

2. The Christmas tree stand of claim 1, wherein the base defines a quarter-circle shape.

3. The Christmas tree stand of claim 1, wherein the base includes an aperture for receiving a trunk.

4. The Christmas tree stand of claim 3, wherein the base includes one or more fasteners for securing a trunk within the aperture.

5. The Christmas tree stand of claim 1, further comprising:
one or more radial extension members, the one or more radial extension members extending radially from the base.

6. The Christmas tree stand of claim 5, further comprising:
a cover disposed over the one or more radial extension members.

7. The Christmas tree stand of claim 5, wherein the one or more radial extension members are removably mountable to the base.

8. The Christmas tree stand of claim 5, wherein the one or more radial extension members are adjustably extensible.

9. The Christmas tree stand of claim 5, further comprising:
a circumferential member coupled to distal ends of the one or more radial extension members.

10. The Christmas tree stand of claim 9, wherein the circumferential member is extensible for placement against a wall.

11. The Christmas tree stand of claim 1, further comprising:
a power outlet for electrically coupling Christmas lights to a wall outlet.

12. The Christmas tree stand of claim 11, further comprising:
an adjustable timer for automatically turning power on and off at certain times.

13. The Christmas tree stand of claim 1, wherein the base is height adjustable.

14. The Christmas tree stand of claim 1, wherein the base is angularly adjustable.

15. The Christmas tree stand of claim 1, further comprising:
one or more lateral extension members, the one or more lateral extension members extending laterally from the base for placement against a wall.

16. The Christmas tree stand of claim 15, wherein the one or more lateral extension members are removably mountable to the base.

17. The Christmas tree stand of claim 16, wherein the one or more lateral extension members are adjustably extensible.

18. The Christmas tree stand of claim 1, wherein the base is composed of a plurality of overlapping fan portions.

19. The Christmas tree stand of claim 18, wherein the plurality of overlapping fan portions are configured to adjustably expand to define various proportions of a circle shape.

20. The Christmas tree stand of claim 1, further comprising:
a Christmas tree configured for placement in a ninety-degree room corner.
